(19) United States
(12) Patent Application Publication
(10) Pub. No.: US 2002/0133702 A1
(43) Pub. Date: Sep. 19, 2002

(54) Methods of granting access to a protected area

(76) Inventor: Curtis E. Stevens, Irvine, CA (US)

Correspondence Address: Claudia Cameron, Phoenix Technologies Ltd., 411 East Plumeria Drive, San Jose, CA, 95134, US

(21) Appl. No.: 09/810,731

(22) Filed: Mar. 16, 2001

(51) Int. Cl. H04L 9/32

(52) U.S. Cl. 713/163; 713/193

(57) ABSTRACT

Methods for granting access to a protected area, such as a PARTIES area of a storage device of a computer, after the computer has been booted. A calling process desiring access to the protected area is caused to locate an interface that interfaces between the calling process and system firmware. The calling process is caused to use the interface to create a trusted relationship between the calling process and the system firmware. Various operations may then be performed. In one embodiment, once the trusted relationship is established, access is allowed to a specific service area in the protected area. Data contained within the service area may then be processed. In another embodiment, once the trusted relationship is established, the service areas found in the protected area may be manipulated. In another embodiment, once the trusted relationship is established, the calling process is allowed access to retrieve a directory of service areas in the protected area. The calling process is allowed access to one or more specific service areas in the protected area. Data contained within the service area is processed. In any of the embodiments, the protected area is closed when processing is complete.

### BACKGROUND

The present invention relates generally to computer systems and methods, and more particularly, to methods that may be used to grant access to a protected area, such as a protected area of a hard disk drive of a computer, after the computer has booted.

Prior art hard disk drives are capable of safely storing firmware (BIOS) in a protected area on spinning media in a tightly integrated system. A tightly integrated system is one where components used for basic operation of the hard drive are interdependent. When the hard drive is a component of a larger system, typically no other firmware components can be safely stored on the hard drive. This protected area is referred to as a vendor protected area. The vendor protected area is typically reserved for firmware of the hard disk drive manufacturer. In general, a fixed area of less than one megabyte of hard disk space is reserved for the vendor protected area.

The following specifications provide information regarding management of a protected area on a hard drive of a computer system: NCITS 346, ANSI NCITS 340 (ATAPI-5), and ANSI NCITS 306 (SCSI-3 Block Commands). The PARTIES and ATA/ATAPI-5 standards allow an area of a hard drive to be both organized and protected. This protection prevents access to the PARTIES area during normal system operation. The PARTIES area is protected from attack by viruses, Trojan horse software, or an unknowledgeable user.

Access to the PARTIES area can be permitted if system firmware, such as the basic input output system (BIOS), does not issue a SETMAX lock command prior to launching the operating system, or if a SETMAX UNLOCK succeeds. The BIOS is a firmware program that is typically stored in nonvolatile memory (flash memory), and which brings up (initializes) a computer system when it is powered on.

Protected Area Run-Time Interface Extensions Services (PARTIES) technology allows a system to reserve space on a hard drive for system use. This space is divided into service areas via a Boot Engineering Extension Record (BEER). The individual service areas can be used for data storage or booting a fail-safe operating system.

When the system boots normally the reserved space is inaccessible, and thus is protected from viruses, ignorant users, and many other acts of god. If the user elects to perform a fail-safe boot, drive letters C: and above operate the way they normally would during a standard boot. The difference is that the system boots from drive A:, where drive A: is simulated from one of the PARTIES service areas. This new capability has several applications including system diagnosis, recovery, and fail-safe applications.

It would be desirable to have a mechanism that allows system firmware to grant access to the PARTIES area during normal system operation. It is an objective of the present invention to provide for improved methods for granting access to a protected area, such as a hard disk drive of a computer. It is a further objective of the present invention to provide for improved methods for granting access to a protected area after the computer has been booted.

### SUMMARY OF THE INVENTION

To accomplish the above and other objectives, the present invention provides for methods for granting access to a protected area, such as a hard disk drive of a computer, after the computer has been booted. A preferred protected area is an area of the hard disk drive known as the PARTIES area. The present invention specifically provides a mechanism for computer system firmware to grant access to the PARTIES area of the hard disk drive during normal computer operation.

The present invention assumes that the following sequence of events has taken place, which sequence occurs during normal booting of the computer, when a power-on-self-test procedure (POST) is run. A hard drive, such as an ATA drive, for example, has been found. A READ NATIVE MAX command has been issued that reads an address indicative of the maximum size of the hard drive. A SETMAX command has been issued using the address returned by the READ NATIVE MAX command which sets the maximum useable size of the hard drive for a user. A BEER sector (or host protected area) has been located using READ commands. A PARTIES service area that contains system firmware has been located. BIOS information, as required, has been read to and written from the service area. A SETMAX command has been issued to the SETMAX ADDRESS located in the host protected area. A SETMAX PASSWORD command has been issued. A SETMAX LOCK command has been issued. The PASSWORD has been stored. The normal operating system boot process has begun. These steps prevent unauthorized access to the PARTIES area by anything accept the system firmware.

In one embodiment, the present invention provides for a method for granting access to a protected area of a storage device from a calling process comprising the following steps. A calling process desiring access to the protected area is caused to locate an interface. The calling process is caused to use the interface to create a trusted relationship between the calling process and system firmware. Once the trusted relationship is established, the calling process is allowed access to retrieve a directory of service areas in the protected area. The calling process is allowed access to one or more specific service areas in the protected area. Data contained within the service area is then processed. The protected area is closed when the processing is complete.

In another embodiment, the present invention provides for a method for granting access to a protected area of a storage device from a calling process comprising the following steps. A calling process desiring access to the protected area is caused to locate an interface. The calling process is caused to use the interface to create a trusted relationship between the calling process and system firmware. Once the trusted relationship is established, access is allowed to a specific service area in the protected area. Data contained within the service area is then processed. The protected area is closed when the processing is complete.

In yet another embodiment, the present invention provides for a method for granting access to a protected area of a storage device from a calling process comprising the following steps. A calling process desiring access to the protected area is caused to locate an interface. The calling process is caused to use the interface to create a trusted relationship between the calling process and system firmware. Once the trusted relationship is established, the service areas found in the protected area are manipulated. The protected area is closed when the processing is complete.

Given that the sequence of events have been implemented, the present invention provides for a programming interface that software can access and which may be used to ask the system firmware to open the PARTIES area. The following is a sample of various functions that may be implemented by the present invention.

A first function is a trust me function that provides for validation that a calling process should have access. There are a variety of methods for two processes to validate each other. One method is to exchange key information. The system firmware could provide the caller with certain data. The caller modifies the data using a private key. The system firmware then determines that the data was modified using a valid key.

A second function is a retrieve service area directory function. Once the system firmware has learned to trust the calling process, it returns a handle. This handle is modified by the calling process and returned as a part of a retrieve directory request or call. The information that is returned by the directory request allows the calling process to locate its service area.

A third function is an open the service area function. Once the system firmware has learned to trust the calling process, it returns a handle. This handle is modified by the calling process and returned as a part of the open service area request or call. If the open request succeeds, the system firmware moves the SETMAX location to allow access to the requested service area.

A fourth function is an open the service area with a password function. Once the system firmware has learned to trust the calling process, it returns a handle. This handle is modified by the calling process and returned as a part of the open service area with a password request or call. If the open request succeeds, the system firmware moves the SETMAX location to allow access to the requested service area. Some service areas may require a special password for access. This password is probably supplied by the user to the calling application. The application then passes the password on to the system firmware as a part of the open service area command.

A fifth function is a close the service area function. When the application has completed its activities in the PARTIES space, the close command returns the SETMAX address to its original boundary.

The above five functions implemented by the present invention allow the system firmware (BIOS) to determine that a trusted application is attempting access and then to grant the requested access.

Other functions may be implemented in practicing the present invention. If a program or process wishes to gain access to the protected (PARTIES) area, it must first locate the programming interface. One way to do this is to place a key string (signature) in memory, such as a “$PARTIES” key string, for example. The program or process may then scan system memory for the signature. The above five functions would immediately follow locating the signature.

Advantages of the present invention over the prior art are as follows. The present invention keeps the protected (PARTIES) area safe, but provides a method for applications to gain access to the protected (PARTIES) area. This enables (1) real time system backup into the protected (PARTIES) area, (2) secure system parameter storage, (3) system firmware changes at runtime, and (4) secure data storage. Furthermore, the protected (PARTIES) area is relatively new to computer systems. The present invention protects the new space.

### BRIEF DESCRIPTION OF THE DRAWINGS

The various features and advantages of the present invention may be more readily understood with reference to the following detailed description taken in conjunction with the accompanying drawing, wherein like reference numerals designate like structural elements, and in which:

FIG. 1 illustrates portion of an exemplary computer system that implements various methods in accordance with the principles of the present invention;

FIG. 2 illustrates a layout of an exemplary hard disk drive having a protected area that may be accessed using methods in accordance with the principles of the present invention;

FIG. 3 illustrates an exemplary layout of hard disk media of an exemplary hard disk drive that may be employed with the present invention;

FIG. 3a is a table that illustrate the PARTIES calling structure employed in the present invention;

FIG. 4 is a flow diagram illustrating exemplary methods in accordance with the principles of the present invention;

FIG. 5 is a flow diagram that illustrates an exemplary trust me procedure implemented in the present invention;

FIG. 6 is a flow diagram that illustrates an exemplary process or method in accordance with the principles of the present invention that implements a retrieve service area directory function;

FIG. 7 is a flow diagram that illustrates an exemplary process or method in accordance with the principles of the present invention that implements an open service area function;

FIG. 8 is a flow diagram that illustrates an exemplary process or method in accordance with the principles of the present invention that implements an open service area with a password function; and

FIG. 9 is a flow diagram that illustrates an exemplary process or method in accordance with the principles of the present invention that implements a close service area function.

### DETAILED DESCRIPTION

By way of introduction, Protected Area Run-Time Interface Extensions Services (PARTIES) technology allows an operating system to reserve space on a hard drive for system use. This space is divided into service areas via a Boot Engineering Extension Record (BEER). The individual service areas can be used for data storage or booting a fail-safe operating system.

When the system boots normally the reserved space is inaccessible, and thus is protected from viruses, ignorant users, and many other acts of god. If a user elects to perform a fail-safe boot, drive letters C: and above operate the way they normally would during a standard boot. The difference is that the system boots from drive A:, where drive A: is simulated from one of the PARTIES service areas. This new capability has several applications including system diagnosis, recovery, and fail-safe applications.

PARTIES technology involves four distinct software layers or phases. The first layer, discovery, detects the presence of a PARTIES area on the hard drive. The second layer, boot selection, provides the user with the ability to choose the fail-safe boot service. The third layer, simulation, provide drive A: from a reserved area on the hard drive when a user chooses to fail-safe boot the system. The fourth layer, manipulation, provides a way to create, delete and access PARTIES services. The ANSI PARTIES specification provides the specific details for formatting and finding PARTIES services.

During the discovery phase, the BIOS checks all drives for the presence of a host protected area (BEER sector). If the host protected area is present, then the drive has PARTIES services available. If no host protected areas are present then all PARTIES capability is disabled.

If fail-safe boot services are found during the discovery phase, the user must be provided with a method to select a boot service. One exemplary method involves integration with PhoenixBIOS MultiBoot 3. MultiBoot 3 provides two methods for boot selection. The first is in SETUP, and the second is via a hotkey during power-on-self-test (POST). When PARTIES technology is present, the user is presented with an option, such as fail-safe boot. When the user selects this option, a menu of boot services is displayed, using a normal MultiBoot 3 menu format. In the case of the hotkey, the selected service is booted.

Another method also involves hotkeys. An OEM may wish to extend the system capabilities by providing buttons, or adding hotkeys, to trigger specific applications. Typical applications may include CD control panels, System Diagnostics, and browsers Another method involves placing icons on the display screen. A user may then select a boot option using a system mouse. Another method involves triggering of a watchdog timer. When the timer fires, system repair is started.

After the user chooses to boot from a PARTIES service area, an INT 13 level simulation is invoked. A SETMAX command is issued to the drive that exposes the entire service area, but leaves other service areas, further out on the drive, protected. Details of the simulation can be found in the ANSI PARTIES specification.

There are two sources of tools for manipulating PARTIES services. The first involves DOS based application, for example. A DOS based tool may be used to initialize the host protected area as well as add and delete PARTIES services. The second involves BIOS based manipulation. BIOS based PARTIES services may be accessed from SETUP as well as at run-time. The SETUP services could allow the user to explicitly initialize create and delete host protected areas and PARTIES services.

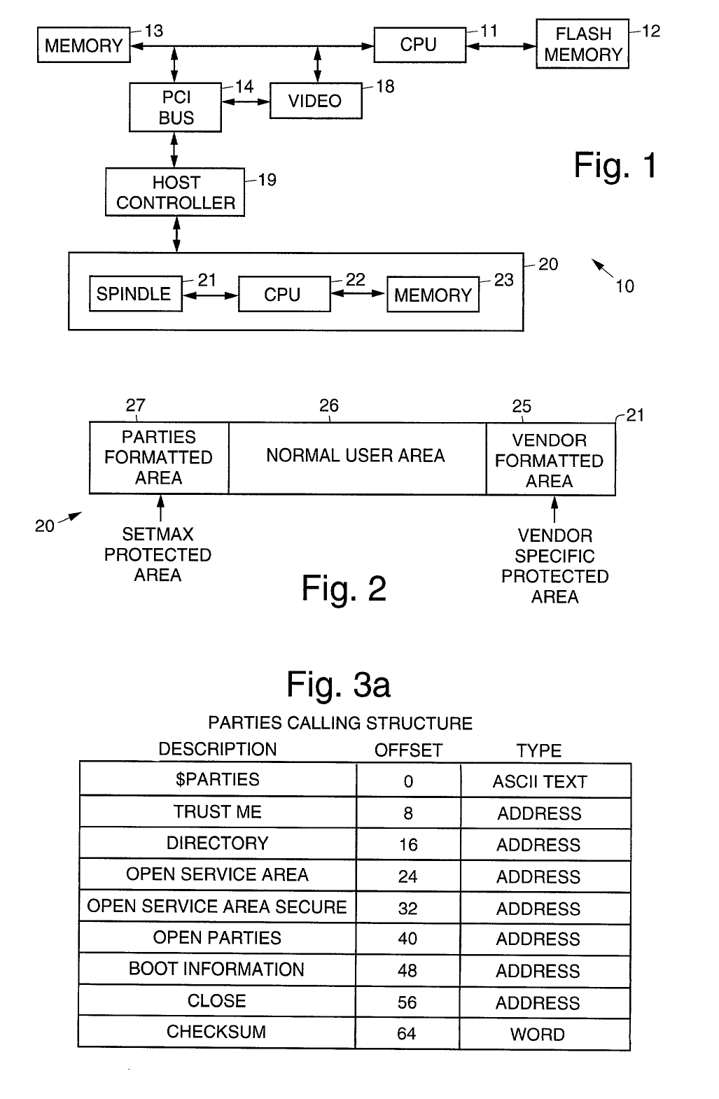

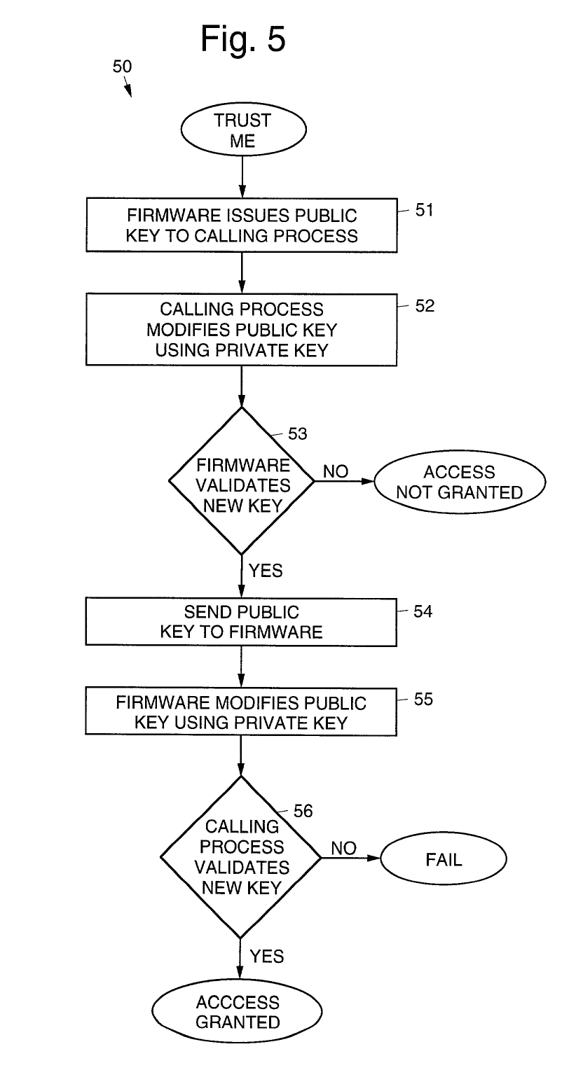

Referring now to the drawing figures, FIG. 1 illustrates an exemplary computer 10, or computer 10, that implements various methods 50 (FIG. 5) in accordance with the principles of the present invention. The methods 50 are used to access a protected area 27 (FIG. 2) after the computer has been booted.

The computer 10 comprises a central processing unit (CPU) 11 that is coupled to a critical nonvolatile storage device 12. The critical nonvolatile storage device 12 may be flash memory, a read only memory (ROM), a programmable read only memory (PROM), an erasable programmable read only memory (EPROM), an electrically erasable programmable read only memory (EEPROM), or other device or technology that the CPU 11 can use to execute an initial set of instructions.

The CPU 11 is also coupled to a system memory 13, such as a random access memory 13. The CPU 11 may be coupled to a secondary nonvolatile storage device 20 by way of a system bus 14, such as a Peripheral Component Interconnect (PCI) bus 14, for example. The secondary nonvolatile storage device 20 may be a hard disk drive, a compact disk (CD) drive, a digital video disk (DVD) drive, a floppy disk drive, a Zip drive, a SuperDisk drive, a Magneto-Optical disk drive, a Jazz drive, a high density floppy disk (HiFD) drive, flash memory, read only memory (ROM), programmable read only memory (PROM), erasable programmable read only memory (EPROM), electrically erasable programmable read only memory (EEPROM), or any other device or technology capable of preserving data in the event of a power-off condition.

A first portion of the critical nonvolatile storage device 12 stores initialization code that is operative to initializes the CPU 11 and the system memory 13. A second portion of the critical nonvolatile storage device 12 stores a dispatch manager that contains a list of tasks, which must execute to fully initialize the computer 10. The dispatch manager is operative to selectively load and iteratively execute a number of tasks relating to complete initialization of the computer.

In operation, when the computer 10 is turned on, the initialization code is run to initialize the CPU 11 and the system memory 13. The dispatch manager is then loaded into the system memory 13. The dispatch manager executes the list of tasks contained therein to cause all required firmware (BIOS modules) to be loaded into the system memory 13 and must be executed.

The dispatch manager determines whether each required BIOS module in the system memory 13, and if it is not, finds, loads and executes each required BIOS module. The BIOS modules may be located in the critical nonvolatile storage device 12 (flash memory) or in the secondary nonvolatile storage device 20, including any of the critical or secondary nonvolatile storage devices 20 identified above.

FIG. 2 illustrates a layout of an exemplary secondary nonvolatile storage device 20 comprising a hard disk drive 20 that has a protected area 27 that may be accessed using methods in accordance with the principles of the present invention. The media of the hard disk drive 20 is broken up into three distinct areas. The first is a vendor protected area 25. The vendor protected area 25 is typically reserved for firmware of the manufacturer of the hard disk drive 20. In general, a fixed area of less than one megabyte of hard disk space is reserved for the vendor protected area 25.

In accordance with the present invention, a second protected area 27 of the hard disk drive 20 (the secondary nonvolatile storage device 20), which may also be referred to as a BIOS protected area 27, contains a plurality of individual BIOS modules for the computer 10. The protected area 27 may be created on the hard disk drive 20 using NCITS 346, ANSI NCITS 340, and ANSI NCITS 306 specifications.

The PARTIES specification specifies how to organize data on the secondary nonvolatile storage device 20. The ATA/ATAPI-5 and SCSI-3 Block Commands provide a means to create a protected space on the secondary nonvolatile storage device 20. As will be described below, the present invention provides methods that permit BIOS modules stored in the protected area 27 to be accessed and modified subsequent to booting of the computer 10.

The following is presented to better understand the PARTIES specification and its use in implementing the present invention. Protected Area Run-Time Interface Extensions Services (PARTIES) technology allows a system to reserve space on a hard drive for system use. This space is divided into service areas via a Boot Engineering Extension Record (BEER). The individual service areas can be used for data storage or for booting a fail-safe operating system.

When the system boots normally, the reserved space is inaccessible, and thus is protected from viruses, unknowledgeable users, and the like. In one embodiment, if a user elects to perform a fail-safe boot using MS-DOS, drive letters C: and above operate the way they normally would during a standard boot. The difference is that the system boots from drive A: instead of C:, where drive A: is simulated from one of the PARTIES service areas. This capability has several applications including system diagnosis, recovery, and fail-safe applications.

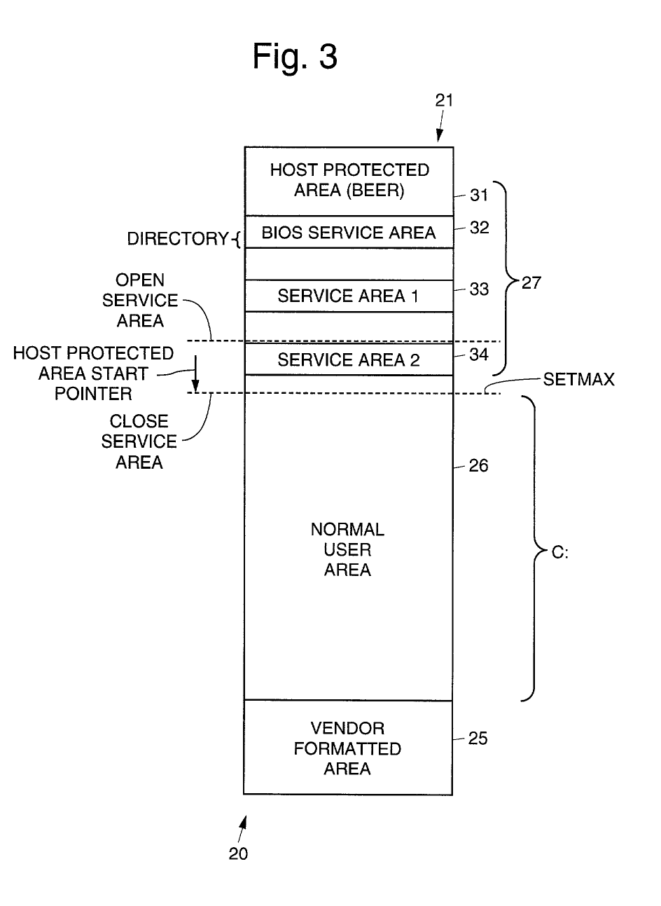

With reference to FIG. 3, it illustrates an exemplary layout of hard disk media 21 of an exemplary hard disk drive 20 that may be employed with the present invention. Using the SETMAX command defined in the ATA/ATAPI-5 specification and the teachings of the PARTIES specification, a disk (media 21) layout illustrated in FIG. 3 may be created.

The hard disk media 21 of the hard disk drive 20 is configured to have the PARTIES formatted area 27, the normal user area 26 (available to a user as drive C:), and the vendor-protected area 25. The vendor-protected area 27 is protected from access by anyone but the manufacturer or vendor of the hard disk drive 20. The normal user area 26 is used to store files and applications by the user in a normal fashion when using the computer 10. The PARTIES formatted area 27, or BIOS protected area 27, stores one or more BIOS modules as was discussed above. These BIOS modules may be accessed using methods in accordance with the present invention to after the computer 10 is in normal operation.

The BIOS retrieves information from the PARTIES formatted area 27 and uses the retrieved information to configure the system. The information stored in the PARTIES formatted area 27 may include option ROMs, BIOS utilities, or other data required to operate the computer 10. In addition, the BIOS may use the PARTIES formatted area 27 to store variables in the same way that variables are stored in the critical nonvolatile storage device 15.

As is shown in the exemplary layout of the hard disk media 21, the SETMAX command defines the upper limit of the normal user area 26. Above the SETMAX limit is the PARTIES formatted area 27. At the upper end of the PARTIES formatted area 27 is a BEER sector 31 (also known as a host protected area 31) which is set by a host protected area start pointer. Below the host protected area 31 is a BIOS service area 32. The BIOS service area 32 contains a directory of services contained in the PARTIES formatted area 27. Below the BIOS service area 32 and above the SETMAX limit are one or more service areas 33, 34, identified as service area 1 and service area 2. These service areas 33, 34 contain various services that may be accessed using methods in accordance with the present invention.

Each of the service areas 33, 34 and the BIOS service area 32 typically have different security levels. The various service areas 32, 33, 34 are more secure as one progresses toward the host protected area 31. As will be discussed below, one or more of the service areas 32, 33, 34 may be accessed by a user, depending upon his or her security level. For example, four security levels may be implemented. The lowest security level “0” would not allow access to the PARTIES formatted area 27. The next highest security level “1” (user security level) would not allow access to selected relatively low level service areas 33, 34. The next highest security level “2” (supervisor security level) would not allow access to selected higher level service areas 33, 34. The highest security level “3” (ultimate security level) would allow access to all service areas 32, 33, 34.

FIG. 3a is a table that illustrate the PARTIES calling structure employed in the present invention. As is shown in FIG. 3a, the PARTIES calling structure includes a variety of calls. The first call is $PARTIES which is at offset 0 and is an ASCII text type. The second call is Trust Me which is at offset 8 and is an address. The third call is directory which is at offset 16 and is an address. The fourth call is Open Service Area which is at offset 24 and is an address. The fifth call is Open Service Area Secure which is at offset 32 and is an address. The sixth call is Open PARTIES which is at offset 40 and is an address. The seventh call is Boot Information which is at offset 48 and is an address. The eighth call is Close which is at offset 56 and is an address. The ninth call is Checksum which is at offset 64 and is a word.

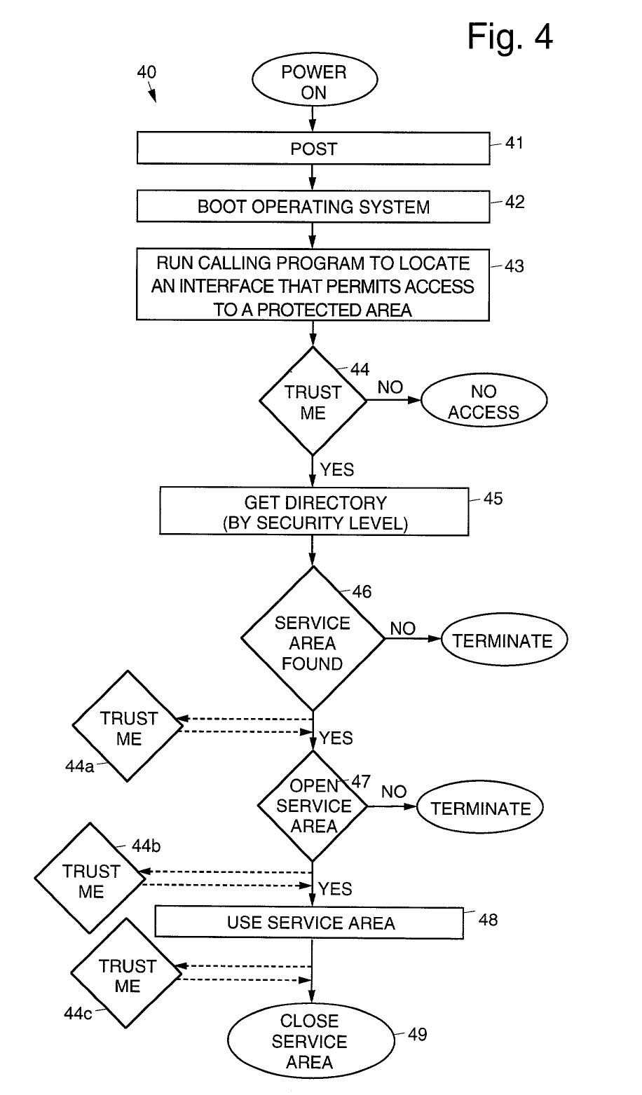

FIG. 4 is a flow diagram illustrating exemplary methods 40 in accordance with the principles of the present invention that may be used to grant access to a protected area 27, such as the PARTIES protected area 27 of a hard disk drive 20, for example, after a computer 10 has been booted. The exemplary methods 40 comprise the following steps.

The computer 10 is powered on. A power-on-self-test procedure (POST) 41 is run. During the power-on-self-test procedure (POST) 41, the following sequence of events takes place. The hard disk drive 20 is found. A READ NATIVE MAX command is issued that reads an address indicative of the maximum size of the hard disk drive 20. A SETMAX command is issued using the address returned by the READ NATIVE MAX command which sets the maximum useable size of the hard disk drive 20 for a user. A host protected area is located using READ commands. A PARTIES service area that contains system firmware is located. BIOS information, as required, is read to and written from the service area. A SETMAX command is issued to the SETMAX ADDRESS located in the host protected area. A SETMAX PASSWORD command is issued. A SETMAX LOCK command is issued. The PASSWORD is stored. The operating system of the computer 10 is then booted 42. These steps prevent unauthorized access to the PARTIES area 27 by any process accept the system firmware.

After the operating system has been booted 42, a calling process is run 43 that desires access to the protected area 27. Then, a trust me decision 44 is made whether to grant access to the protected area 27. The trust me decision 44 involves creating a trusted relationship between a calling process and system firmware. If the trusted relationship is not created, then no access to the protected area 27 is not granted. However, if the trusted relationship is created, then access to the protected area 27 is granted and a service directory is retrieved 45.

The calling process then may attempt to access one or more specific service areas 32, 33, 34 identified in the service directory. As was mentioned above, this is generally granted based upon a predetermined security level. If the requested service area 32, 33, 34 is not found 46, then the process is terminated. If the requested service area 32, 33, 34 is found 46, then a request to open 47 the requested service area 32, 33, 34 is made. If the requested service area 32, 33, 34 is not opened, then the process terminates. If the requested service area 32, 33, 34 is opened, then it may be used 48 or operated upon 48. After the user is finished using the requested service area 32, 33, 34, the service area 32, 33, 34 is closed 49.

It is to be understood that additional trust me decisions 44a, 44b, 44c may be used between each of the various operations, such as when the service area is opened 47 and when it is used 48, and when the service area is opened 47, when it is used 48, and when it is closed 49.

Three specific embodiments of the methods 40 disclosed with reference to FIG. 4 are as follows. A first method 40 for granting access to a protected area 27 of a storage device from a calling process comprises the following steps. A calling process desiring to gain access to the protected area 27 is caused to locate an interface that permits access to the protected area 27. The calling process to use the interface is caused to create a trusted relationship 44 between the calling process and system firmware. Once the trusted relationship 44 has been established, the calling process is allowed access to retrieve 45 a directory of service areas in the protected area 27. Access to one or more service areas in the protected area 27 is allowed. Data contained in the one or more service areas is processed 48. The protected area 27 is closed 49 when processing data in the one or more service areas is complete.

A second method 40 for granting access to a protected area 27 of a storage device from a calling process comprises the following steps. A calling process desiring to gain access to the protected area 27 is caused to locate an interface that permits access to the protected area 27. The calling process to use the interface is caused to create a trusted relationship 44 between the calling process and system firmware. Once the trusted relationship 44 has been established, access to a one or more service areas in the protected area 27 is allowed. Data contained in the one or more service areas is processed 48. The protected area 27 is closed 49 when the processing in the one or more service areas is complete.

A third method 40 for granting access to a protected area 27 of a storage device 20 from a calling process comprises the following steps. A calling process desiring to gain access to the protected area 27 is caused to locate an interface that permits access to the protected area 27. The calling process to use the interface is caused to create a trusted relationship 44 between the calling process and system firmware. Once the trusted relationship 44 has been established, one or more service areas found in the protected area 27 are manipulated 48. The protected area 27 is closed 49 when the processing in the one or more service areas is complete.

The present invention thus provides for a programming interface (implemented in accordance with the present methods) that software (the calling process) can find and which can be used to ask the system firmware to open the protected (PARTIES) area 27. Once the protected (PARTIES) area 27 is accessed, a user may use the calling process to perform various tasks in the protected (PARTIES) area 27. The following is a sample of the functions that are provided by the present invention.

A first function is a trust me function or decision 44 that provides for validation that a calling process should have access to the protected (PARTIES) area 27. There are a variety of methods for two processes to validate each other. One method is to exchange key information. The system firmware could provide the calling process with certain data. The calling process modifies the data using a private key. The system firmware then determines that the data was modified using a valid key. The following procedure 50 details such a trust me function or decision 44.

FIG. 5 is a flow diagram that illustrates an exemplary trust me procedure 50 implemented in the present invention. In implementing the exemplary trust me procedure 50, The system firmware issues 51 a public key to the calling process. The calling process then modifies 52 the public key using the private key. A decision is made by the system firmware to validate 53 the new key. If the key is not validated, then access is not granted. If the key is validated, a public key is sent 54 to the system firmware. The system firmware modifies 55 the public key using a private key. A decision is made by the calling process to validate 56 the modified key. If the key is not validated, then the trust me procedure fails. If the key is validated, then access is granted.

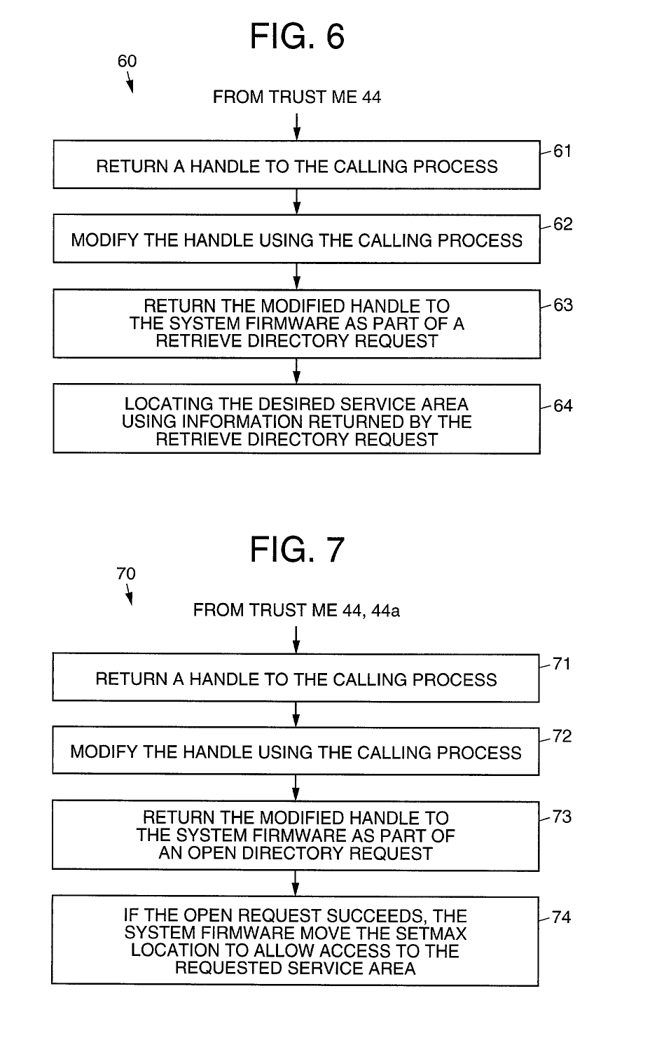

A second function is a retrieve service area directory function 45, which is implemented by the above-discussed directory retrieval step 45. An exemplary retrieve service area directory function 45 may be implemented as follows, with reference to FIG. 6. FIG. 6 is a flow diagram that illustrates an exemplary process 60 or method 60 in accordance with the principles of the present invention that implements the retrieve service area directory function 45 and thus retrieves the service area directory from the protected area 27.

Referring to FIG. 6, once the system firmware has learned to trust 44 the calling process, it returns 61 a handle. This handle is modified 62 by the calling process and returned 63 as a part of the retrieve directory request or call. The information that is returned by the retrieve directory request or call allows the calling process to locate 64 the desired service area.

A third function is an open service area function 47 which is implemented by the above-discussed opening step 47. An exemplary open service area function 47 may be implemented as follows, with reference to FIG. 7. FIG. 7 is a flow diagram that illustrates an exemplary process 70 or method 70 in accordance with the principles of the present invention that implements the open service area function 47 and thus opens the requested service area in the protected area 27.

Referring to FIG. 7, once the system firmware has learned to trust 44 the calling process, it returns 71 a handle. This handle is modified 72 by the calling process and returned 73 as a part of the open service area request or call. If the open request succeeds, the system firmware moves 74 the SETMAX location to allow access to the requested service area. This is illustrated in FIG. 3 which shows movement of the SETMAX location from its initial boundary to a boundary above service area 2.

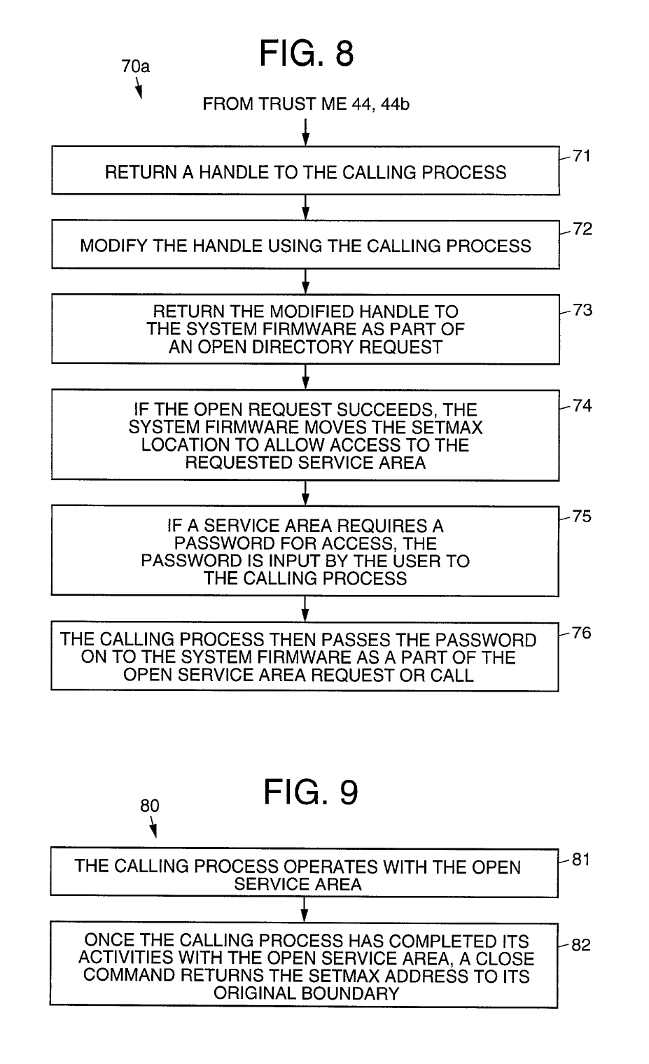

A fourth function is a modification of the open service area function 47 which comprises an open the service area with a password function 47aAn exemplary open service area with a password function 47a may be implemented as follows, with reference to FIG. 8. FIG. 8 is a flow diagram that illustrates an exemplary process 70a or method 70a in accordance with the principles of the present invention that implements the open service area with a password function 47a and thus opens the requested service area in the protected area 27 using a password.

Referring to FIG. 8, once the system firmware has learned to trust 44 the calling process, it returns a handle 71. This handle is modified 72 by the calling process and returned 73 as a part of the open service area with a password request or call. If the open request succeeds, the system firmware moves 74 the SETMAX location to allow access to the requested service area. This is illustrated in FIG. 3 which shows movement of the SETMAX location from its initial boundary to a boundary above service area 2. If a service area requires a password for access, the password is input 75 by the user to the calling process. The calling process then passes 76 the password on to the system firmware as a part of the open service area request or call.

A fifth function is a close service area function 49, which is implemented by the above-discussed closing step 49. This closing step 49 is illustrated in FIG. 9. FIG. 9 is a flow diagram that illustrates an exemplary process 80 or method 80 in accordance with the principles of the present invention that implements the close service area function 49. The calling process operates 81 with the various service areas 32, 33, 34 within the protected area 27. Once the calling process has completed its activities in the protected area 27, a close command returns 82 the SETMAX address to its original boundary. This is illustrated in FIG. 3 which shows movement of the SETMAX location from the boundary above service area 2 to its initial boundary.

The above-described five functions implemented by the present invention allow the system firmware to determine that a trusted application is attempting access and then to grant the requested access.

Run-time services allow the calling process or application to gain access to the protected (PARTIES) area 27. The run-time services includes the following functions.

The trust me function is a mechanism that validates the calling application. This involves the exchange of public and private keys.

A create service function adds an entry in the host protected area for a new protected (PARTIES) area 27. This operation requires that the calling application (calling process) guarantee that the space to be consumed by the new protected (PARTIES) area 27 is not in use by the conventional operating system (OS) file system.

A delete service function deletes an entry from the host protected area and compresses the remaining data. There can be no blank spaces in the protected (PARTIES) area 27. An application can then expand the OS file system to use the newly created free space.

The directory function returns a list of available services by filling a buffer provided by the calling application or process.

The open service function makes the selected PARTIES area accessible. This has the effect of exposing the selected PARTIES area as well as those that are before the selected service area on the hard drive. Once a service area is opened, it can be accessed via INT 13 at the end of the drive.

These five functions allow an application to fully manipulate the protected (PARTIES) area 27 while enabling the BIOS (system firmware) to maintain control of the host protected area. The operation of the interface provided by the present invention maintains the security of the protected (PARTIES) area 27. Therefore, the first command issued to the PARTIES services is the trust me command. If this is successful then a selected PARTIES service can be executed.

The present invention may be used for system diagnosis and recovery. A large percentage of hard drives returned to OEMs have no physical defect. The user may have been infected with a virus that deleted a critical file, or is suffering from a failed install. These events can result in a drive returned to the system vendor. The PARTIES area provides a safe area to place diagnostic and recovery applications. In the event of a boot failure, the user can start the diagnosis and recovery services. In the event of a technical support call, a technician could ask the user to initiate the system diagnostics. This capability will lead to fewer disk drive returns.

Many laptop computers come equipped with a CD-ROM or DVD drive. Currently, the Windows operating system must be fully initialized in order to control the drive. A PARTIES service that can perform CD and volume control functions would be useful. Furthermore, a PARTIES based browser could allow the user instant access to the Internet as well as providing considerable power savings during the browsing operation.

Generally, PARTIES services are triggered during the boot process. However, it is also possible to start a PARTIES service during a suspend or resume operation. This capability allows a user to diagnose a problem without disturbing the current on-line application or session. Since PARTIES applications can be optimized for power consumption on an application basis, fail-safe applications may be used to prolong battery life.

Thus, methods for granting access to a protected area, such as a hard disk drive of a computer, have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. A method for granting access to a protected area of a storage device from a calling process, comprising the steps of:
causing a calling process desiring to gain access to the protected area to locate an interface that permits access to the protected area;
causing the calling process to use the interface to create a trusted relationship between the calling process and system firmware;
once the trusted relationship has been established, allowing the calling process access to retrieve a directory of service areas in the protected area;
allowing access to one or more service areas in the protected area;
processing data contained in the one or more service areas; and
closing the protected area when processing data in the one or more service areas is complete.

2. The method recited in claim 1 wherein the trusted relationship comprises the steps of:
sending a public key to the system firmware;
modifying the public key using a private key using the system firmware;
causing the calling process to validate the modified key;
causing the system firmware to issues a public key to the calling process;
modifying the public key using the private key using the calling process;
causing the system firmware to validate the new key; and
if the key is not validated, granting not access to the protected area; and
if the key is validated, granting access to the protected area.

3. The method recited in claim 1 wherein the step of allowing access to the one or more service areas comprises the steps of:
returning a handle from the system firmware to the calling process once the system firmware has learned to trust the calling process;
modifying the handle using the calling process;
returning the modified handle to the system firmware as a part of the retrieve directory request; and
allowing the calling process to locate the desired service area using the information returned by the retrieve directory request.

4. The method recited in claim 1 wherein the step of allowing access to the one or more service areas comprises the steps of:
returning a handle from the system firmware to the calling process once the system firmware has learned to trust the calling process;
modifying the handle using the calling process;
returning the modified handle to the system firmware as a part of a retrieve directory request; and
if the open request succeeds, causing the system firmware to move a SETMAX boundary to allow access to the requested service area.

5. The method recited in claim 1 wherein the step of allowing access to the one or more service areas comprises the steps of:
returning a handle from the system firmware to the calling process once the system firmware has learned to trust the calling process;
modifying the handle using the calling process;
returning the modified handle to the system firmware as a part of an open service area with a password request; and
if the open request succeeds, causing the system firmware to move a SETMAX boundary to allow access to the requested service area.

6. The method recited in claim 1 wherein the step of closing the protected area comprises the step of:
once the calling process has completed its activities in the protected area 27, returning the SETMAX address to its original boundary using a close command.

7. A method for granting access to a protected area of a storage device from a calling process, comprising the steps of:
causing a calling process desiring to gain access to the protected area to locate an interface that permits access to the protected area;
causing the calling process to use the interface to create a trusted relationship between the calling process and system firmware;
once the trusted relationship has been established, allowing access to a one or more service areas in the protected area;
processing data contained in the one or more service areas; and
closing the protected area when the processing in the one or more service areas is complete.

8. The method recited in claim 7 wherein the trusted relationship comprises the steps of:
sending a public key to the system firmware;
modifying the public key using a private key using the system firmware;
causing the calling process to validate the modified key;
causing the system firmware to issues a public key to the calling process;
modifying the public key using the private key using the calling process;
causing the system firmware to validate the new key; and
if the key is not validated, not granting access to the protected area; and
if the key is validated, granting access to the protected area.

9. The method recited in claim 7 wherein the step of allowing access to the one or more service areas comprises the steps of:
returning a handle from the system firmware to the calling process once the system firmware has learned to trust the calling process;
modifying the handle using the calling process;
returning the modified handle to the system firmware as a part of the retrieve directory request; and
allowing the calling process to locate the desired service area using the information returned by the retrieve directory request.

10. The method recited in claim 7 wherein the step of allowing access to the one or more service areas comprises the steps of:
returning a handle from the system firmware to the calling process once the system firmware has learned to trust the calling process;
modifying the handle using the calling process;
returning the modified handle to the system firmware as a part of a retrieve directory request; and
if the open request succeeds, causing the system firmware to move a SETMAX boundary to allow access to the requested service area.

11. The method recited in claim 7 wherein the step of allowing access to the one or more service areas comprises the steps of:
returning a handle from the system firmware to the calling process once the system firmware has learned to trust the calling process;
modifying the handle using the calling process;
returning the modified handle to the system firmware as a part of an open service area with a password request; and
if the open request succeeds, causing the system firmware to move a SETMAX boundary to allow access to the requested service area.

12. The method recited in claim 7 wherein the step of closing the protected area comprises the step of:
once the calling process has completed its activities in the protected area 27, returning the SETMAX address to its original boundary using a close command.

13. A method for granting access to a protected area of a storage device from a calling process, comprising the steps of:
causing a calling process desiring to gain access to the protected area to locate an interface that permits access to the protected area;
causing the calling process to use the interface to create a trusted relationship between the calling process and system firmware;
once the trusted relationship has been established, manipulating one or more service areas found in the protected area;
closing the protected area when the processing in the one or more service areas is complete.

14. The method recited in claim 13 wherein the trusted relationship comprises the steps of:
sending a public key to the system firmware;
modifying the public key using a private key using the system firmware;
causing the calling process to validate the modified key;
causing the system firmware to issues a public key to the calling process;
modifying the public key using the private key using the calling process;
causing the system firmware to validate the new key; and
if the key is not validated, not granting access to the protected area; and
if the key is validated, granting access to the protected area.

15. The method recited in claim 13 wherein the step of allowing access to the one or more service areas comprises the steps of:
returning a handle from the system firmware to the calling process once the system firmware has learned to trust the calling process;
modifying the handle using the calling process;
returning the modified handle to the system firmware as a part of the retrieve directory request; and
allowing the calling process to locate the desired service area using the information returned by the retrieve directory request.

16. The method recited in claim 13 wherein the step of allowing access to the one or more service areas comprises the steps of:
returning a handle from the system firmware to the calling process once the system firmware has learned to trust the calling process;
modifying the handle using the calling process;
returning the modified handle to the system firmware as a part of a retrieve directory request; and
if the open request succeeds, causing the system firmware to move a SETMAX boundary to allow access to the requested service area.

17. The method recited in claim 13 wherein the step of allowing access to the one or more service areas comprises the steps of:
returning a handle from the system firmware to the calling process once the system firmware has learned to trust the calling process;
modifying the handle using the calling process;
returning the modified handle to the system firmware as a part of an open service area with a password request; and
if the open request succeeds, causing the system firmware to move a SETMAX boundary to allow access to the requested service area.

18. The method recited in claim 13 wherein the step of closing the protected area comprises the step of:
once the calling process has completed its activities in the protected area 27, returning the SETMAX address to its original boundary using a close command.
